(19) United States
(12) Patent Application Publication
(10) Pub. No.: US 2009/0210289 A1
(43) Pub. Date: Aug. 20, 2009

(54) Pre-Linguistic Product Evaluation Techniques

(75) Inventors: August V.I. de los Reyes, Bellevue, WA (US); Dennis R. Wixon, Snohomish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/034,622

(22) Filed: Feb. 20, 2008

(51) Int. Cl. G06Q 10/00

(52) U.S. Cl. 705/10; 705/7

(57) ABSTRACT

Pre-linguistic product evaluation techniques are described. In an implementation, a pre-linguistic evaluation is obtained of one or more products and two or more anchor products, respectively, in which the two or more anchor products exhibit an intended design behavior of the one or more products. A linguistic basis is then collected for the pre-linguistic evaluation of the one or more products after the pre-linguistic evaluation is performed.

### BACKGROUND

Product evaluation (e.g., testing) continues to be an important way in which product manufacturers may determine whether products are suitable for market, how to market the products, and so on. Although a variety of different techniques were developed to perform product evaluation, these traditional techniques may result in inaccurate product evaluations due to a variety of factors.

In one such traditional technique, for instance, product testers in a product evaluation group were asked to articulate their interaction with a product. For example, the product testers may be asked questions by a product investigator that is running an evaluation session their “feelings” regarding a design. However, this traditional technique may be limited by the ability of each of the product testers to articulate their interaction, such as their grasp of language and how to articulate what is “felt” during interaction with the product. Further, the meaning behind language that is used by the product testers may vary, one to another, thereby skewing results even when similar language is collected from different product testers.

In another such traditional technique, product testers are asked to “rate” various product categories using a predetermined scale. The product testers, for instance, may be given a scale from one to five and are asked to rate different characteristics of a product. However, the various characteristics as well as the use of the scale may also skew the results. For example, the characteristics that are being ranking may not follow the characteristics that would be chosen by the members. In other words, an underlying “feeling” behind a product tester's experience with a product may not be available. Thus, the product testers may supply rankings to characteristics that do not accurately reflect their experience with the product.

### SUMMARY

Pre-linguistic product evaluation techniques are described. In an implementation, a pre-linguistic evaluation is obtained of one or more products and two or more anchor products, respectively, in which the two or more anchor products exhibit an intended design behavior of the one or more products. A linguistic basis is then collected for the pre-linguistic evaluation of the one or more products after the pre-linguistic evaluation is performed.

In an implementation, an intended design behavior of one or more products is determined. Two or more anchor products are selected that exhibit varying degrees of the intended design behavior. The product is evaluated by obtaining a pre-linguistic evaluation of the one or more products and the two or more anchor products and then collecting a linguistic basis for the pre-linguistic evaluation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ pre-linguistic product evaluation techniques.

FIG. 2 is a flow diagram depicting a procedure in an exemplary implementation in which a pre-linguistic evaluation and a linguistic basis for the evaluation of a product is obtained.

FIGS. 3-6 depict example graphs that may be incorporated within a product evaluation report.

### DETAILED DESCRIPTION

### Overview

An expression of an experience with a product may be quite different than an actual “feeling” experienced by a product tester when interacting with the product. Consequently, traditional product evaluation techniques were limited by the product tester's knowledge of language and ability to understand and express these “feelings” using language.

Techniques are described to obtain qualitative data about product design that is not based solely on linguistic articulation. In an implementation, a magnitude estimation technique is employed that obtains evaluations in a “pre-linguistic” form, e.g., without display or input of letters or numbers to or by a product tester. A linguistic basis for the pre-linguistic evaluation is then collected, thereby supplying the reasoning for the evaluation without pre-conditioning a product tester to particular characteristics before the pre-linguistic evaluation is obtained, as was done using traditional “ranking” techniques.

For example, a product evaluation may be performed in which two products of a same type are first evaluated, e.g., vegetable peelers. One peeler in this example is an award-winning product that is recognized for good design and the other is a basic peeler that is capable of accomplishing an identical task, but is less sophisticated. Thus, the vegetable peelers supply varying degrees of an intended product design.

As testers familiarize themselves with both peelers through actual usage, the memories of each experience are used as anchor points on a pre-linguistic scale for a subsequent product to be tested, e.g., a new vegetable peeler. Thus, the anchor products may serve as a basis for comparison with a product to be evaluated.

The pre-linguistic scale, for instance, may be established through use of an analog dial that controls a grayscale display on a display device of a computer, e.g., from light to dark and vice versa. The product tester may interact with the dial to select a shade of gray that most closely represents the product tester's experience with the anchor products as well as the product to be evaluated. Thus, a pre-linguistic evaluation of the new vegetable peeler may be readily compared with the pre-linguistic evaluations of the anchor products, e.g., the award winning vegetable peeler and the basic vegetable peeler.

After the pre-linguistic evaluation is collected (e.g., by picking a particular shade of gray using the analog dial), the product testers may then supply a linguistic basis for respective evaluations. In this way, the product evaluation may determine a basis for the pre-linguistic evaluations without preconditioning the product testers and without relying on a product tester's ability to articulate differences for how the tester “feels” about the different products, e.g., to supply differences in magnitude.

Continuing with the vegetable peeler example, a product designer may wish to develop a new vegetable peeler. Additionally, the product designer may assume that it is the “smoothness” in the way the peeler operates (e.g., peels) that is desired by prospective purchasers and design the new vegetable peeler accordingly. However, a product evaluation performed using the above referenced technique may uncover that while the new vegetable peeler is somewhat well received (e.g., the pre-linguistic evaluation is closer to the award winning vegetable peeler than the basic vegetable peeler), it is the grip of the vegetable peelers that serve as a linguistic basis for the pre-linguistic evaluation. For example, the product testers may supply relatively “high” evaluations for the new vegetable peeler, but supply a linguistic basis for that evaluation as “how the vegetable peelers felt when picked up” as opposed to “smoothness in operation” as was expected by the product designer. Accordingly, the product designer may take this into account in further refinements to the new vegetable peeler,

Thus, because the product evaluation techniques do not uncover specific criteria until after the pre-linguistic evaluation, these techniques may provide a useful source for design criteria that may isolate specific product behavior. Further, the pre-linguistic evaluation may be used to measure a similar quality in different types of products through direct product behavior, further discussion of which may be found in relation to following discussion.

In the following discussion, an example environment is first described that is configured to provide pre-linguistic product evaluation. An example procedure is then described which may be employed in the example environment, as well as in other environments. An implementation example is then described that involves an example product evaluation session.

### Example Environment

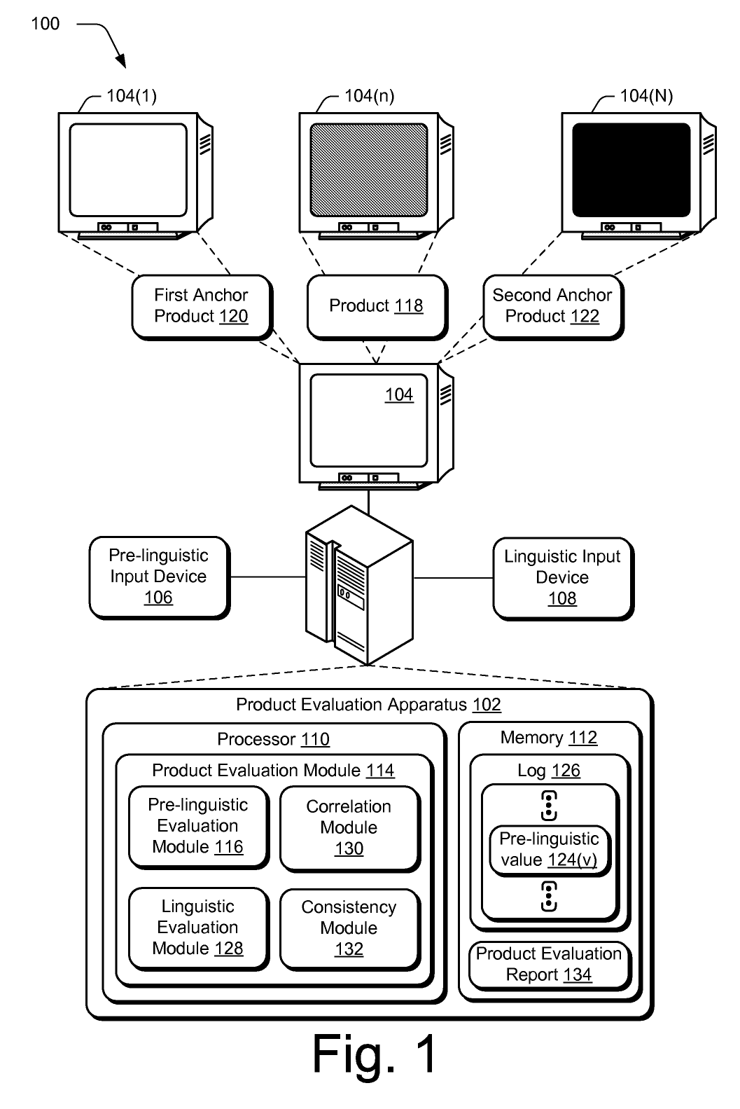

FIG. 1 is an illustration of an environment 100 in an example implementation that is operable to employ pre-linguistic product evaluation techniques. The illustrated environment 100 includes a product evaluation apparatus 102 having a display device 104, a pre-linguistic input device 106 and a linguistic input device 108. The product evaluation apparatus 102 may be configured in a variety of ways, such as a personal computer as illustrated, a mobile station, a server, and so forth.

The product evaluation apparatus 102 is further illustrated as including a processor 110 and memory 112. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 112 is shown, a wide variety of types and combinations of memory may be employed, such as random access memory (RAM), hard disk memory, removable medium memory, and other types of computer-readable media.

The product evaluation apparatus 102 is also illustrated as including a product evaluation module 114, which is illustrated as being executed on the processor 110 and is storable in memory 112. The product evaluation module 114 is representative of functionality to process data related to a product evaluation performed using pre-linguistic techniques.

The pre-linguistic evaluation module 116, for instance, is representative of functionality to obtain a pre-linguistic evaluation of a product 118. Accordingly, the pre-linguistic input device 106 may be configured to be manipulated by a user without output (e.g., via the display device) or input of numbers or letters by a user of the product evaluation apparatus 102, e.g., a product tester.

For example, the pre-linguistic input device 106 may be configured as a dial that causes a grayscale output to change from darker to lighter and vice versa, examples of which are shown in phantom in FIG. 1 by display devices 104(1), 104(n) and 104(N) showing white, gray and black displays, respectively. A variety of other pre-linguistic techniques may also be employed, such as by a “slider” input device, use of speakers to output different tones in an audio range, and so on.

A product tester, for instance, may be presented with a first anchor product 120 and a second anchor product 122 that are to serve as a basis for comparison with a product 118 to be evaluated. The product tester may manipulate the pre-linguistic input device 106 to represent an experience with the first anchor product 120, which is shown by a white screen on display device 104(1). When a desired representation is output (e.g., a particular shade of gray), the product tester may cause the pre-linguistic evaluation module 116 to compute a pre-linguistic value 124(v) (where “v” may be an integer between one and “V”) that is stored in a log 126 in memory 112. The pre-linguistic value 124(v) is representative of the output displayed on the display device 104, such as a value of 0-255 for varying degrees in a grayscale.

Likewise, the product tester may manipulate the pre-linguistic input device 106 to represent an experience with the second anchor product 122, which is illustrated by a black screen on display device 104(N). This experience may also be stored in the log 126. The product tester may also manipulate the pre-linguistic input device 106 to represent an experience with the product 118 to be evaluated, which causes another pre-linguistic value 124(v) to be stored in the log 126. Thus, the inputs received by the pre-linguistic evaluation module 116 may form a scale to compare the product 118 with the first and second anchor products 120, 122.

The linguistic evaluation module 128 is representative of functionality to collect a linguistic basis for the pre-linguistic evaluation collected by the pre-linguistic evaluation module 116. The linguistic input device 108, for instance, may be configured as a keyboard, cursor control device or other input device that is configured to collect language from product testers describing a reason for the pre-linguistic values 124(v) collected in the log 126. The language may be collected directly (e.g., through manual and/or spoken entry by the product tester) or indirectly (e.g., through input by a product investigator that “runs” a product evaluation session when speaking with the product tester).

The product evaluation module 114 is also illustrated as including a correlation module 130 that is representative of functionality to correlate the pre-linguistic values 124(v) in the log 126 from the pre-linguistic evaluation module 116 with the linguistic basis from the linguistic evaluation module 128. The correlation module 130, for instance, may use a product tester identifier (e.g., an assigned number), full or partial name of the product tester, date and time, and so on.

The product evaluation module 114 is further illustrated as including a consistency module 132 that is representative of functionality to “check” whether the pre-linguistic values are consistent, such as through use of another pre-linguistic technique. For example, the product tester may be asked to place product(s) to be evaluated, with or without anchor products, in an ordinal ranking, one after another. This ordinal ranking may then be compared with the pre-linguistic values 124(v) in the log 126 to determine consistency, e.g., that the pre-linguistic values 124(v) given for the products correspond with the ordinal ranking. A variety of actions may be taken when the values are not consistent, such as by deleting from the log 126 pre-linguistic values 124(v) that are not consistent for a product tester.

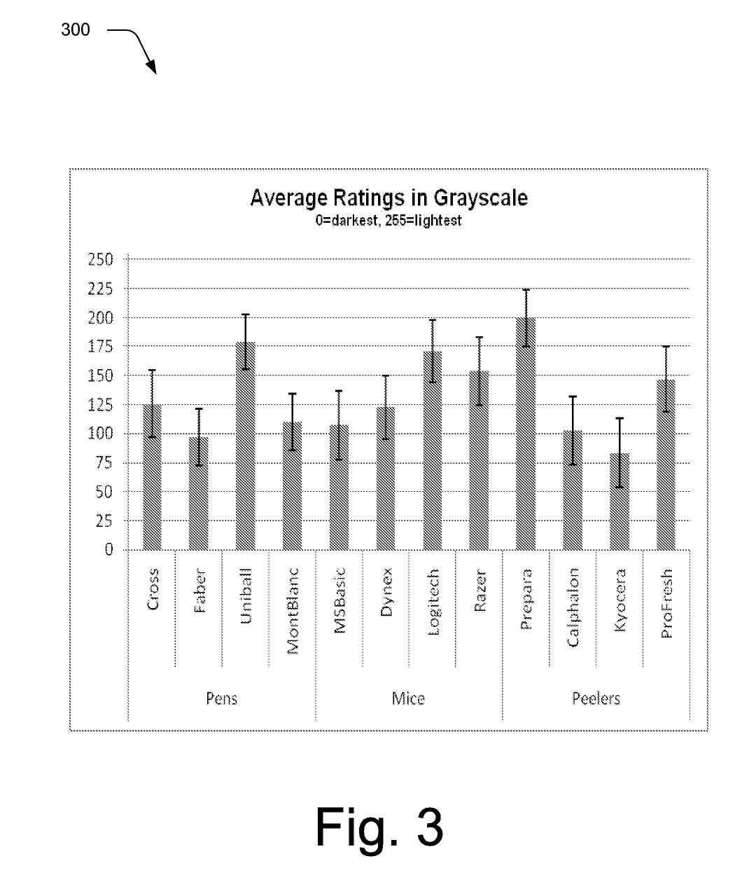

The product evaluation module 114 may then output a result of the product evaluation, an example of which is the product evaluation report 134 that is illustrated as being stored in memory 112. The product evaluation report 134 may utilize a variety of techniques to process the pre-linguistic values 124(v) and the linguistic basis, examples of which may be found in relation to FIGS. 3-6.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, an example of which is the memory 112 of FIG. 1. The features of the pre-linguistic product evaluation techniques described below are platform-independent, meaning that the techniques may be implemented on a variety of commercial computing platforms having a variety of processors.

### Example Procedure

The following discussion describes product evaluation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1.

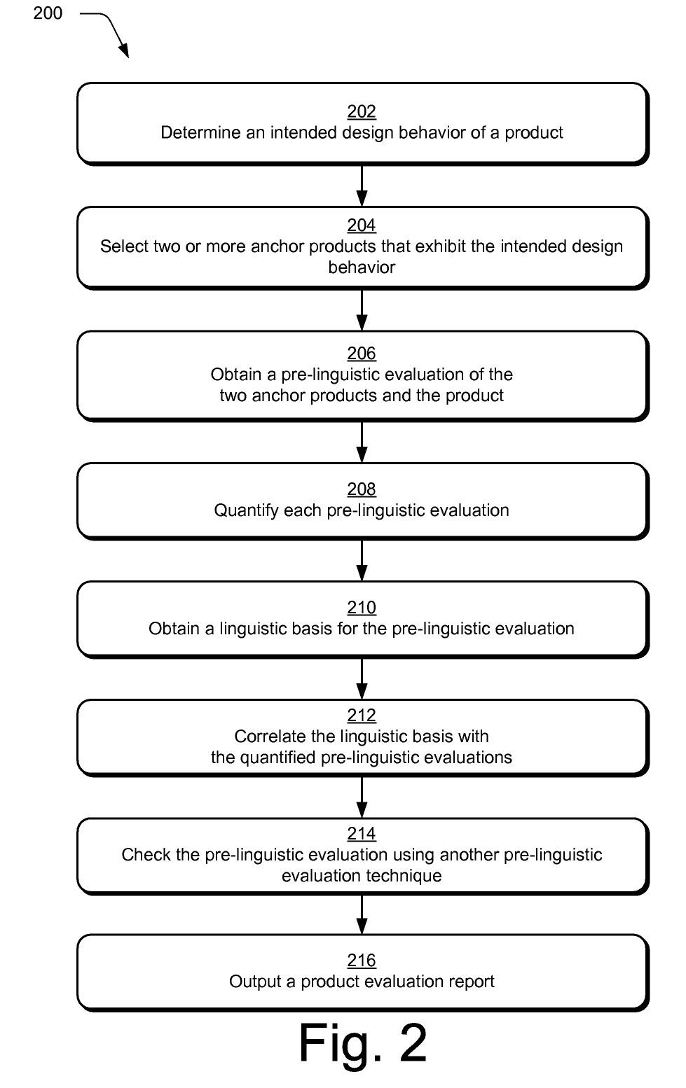

FIG. 2 depicts a procedure 200 in an example implementation in which a pre-linguistic evaluation and a linguistic basis for the evaluation of a product is obtained. An intended design behavior of a product is determined (block 202). For example, a product designer may design a hinge for a laptop computer and therefore the intended design behavior relates to operation of the hinge, such as how a prospective purchaser “feels” when using the hinge.

Two or more anchor products are selected that exhibit the intended design behavior (block 204). Continuing with the previous example, the product designer may have as a goal that the hinge of the laptop computer mimics the action of a hinge of a well respected brief case. Therefore, the product designer and/or product investigator may select the brief case as one of the anchor products. Additional anchor products are also chosen such that the anchor products exhibit varying degrees of the intended design behavior. For example, another anchor product may be chosen that has a less desirable hinge, e.g., luggage having a hinge that binds and is loose fitting. Thus, the brief case may be considered a “goal” of an intended design behavior and the luggage may exhibit the intended design behavior to a less than desirable degree.

A pre-linguistic evaluation of the two anchor products and the product is obtained (block 206) and then quantified for each pre-linguistic evaluation (block 208). A product tester, for instance, may iteratively manipulate the pre-linguistic input device 106 to cause an output of a particular shade of gray that is representative of the anchor products and the product to be evaluated, respectively. Pre-linguistic values 124(v) (e.g., value of 0-255) that correspond to selected shades of gray are stored in a log 126 in the memory 112. In an implementation, the pre-linguistic values 124(v) are kept “secret” from the product tester until after the linguistic basis for the pre-linguistic evaluation is collected. Although adjustment of a grayscale display has been described, a variety of other techniques are also contemplated, such as pushing a lever that provides increasing resistance, adjusting color saturation or a variety of other methods that involve making a bodily movement in order to change a stimulate for the purpose of expressing a preference.

A linguistic basis for the pre-linguistic evaluation is obtained (block 210). The product tester, for instance, may at this point interact with the linguistic input device 108 (e.g., a keyboard and/or microphone) directly or indirectly to explain what characteristics of the product 118 and the first and second anchor products 120, 122 were evaluated. In this way, the product tester may explain as to “what” the pre-linguistic values 124(v) quantify.

The linguistic basis may then be correlated with the quantified pre-linguistic evaluations (block 212), such as by assigning a user name or other identifier to the log 126 that may also include the input linguistic basis.

The pre-linguistic evaluations may also be checked using another pre-linguistic evaluation technique (block 214). The product tester, for instance, may be asked to place the one or more products in a ranking, e.g., from least desirable to most desirable using an ordinal ranking, interval or ratio ranking. This ranking may be used to check consistency with the pre-linguistic values 124(v).

A product evaluation report may then be output (block 216), which may take a variety of configurations. For example, a “simple” product evaluation report 134 may include the log 126 having pre-linguistic values 124(v) that are correlated with a linguistic basis for the values. Additional more “advanced” product evaluation reports 134 are also contemplated, examples of which may be found in relation to the following discussion. Although a specific order was discussed, a variety of different orders for the blocks of FIG. 2 are contemplated, such as to use a ranking before a pre-linguistic evaluation.

### Example Implementation

This implementation takes two products of the same category, in this case, vegetable peelers. One peeler is an award-winning product recognized in the public discourse for good design, and the other is a more basic peeler that, even though it accomplishes an identical task, is less sophisticated, e.g., exhibits less affordance for physical stimulus. Thus, the peelers offer varying degrees of compliance with an intended design behavior.

As product testers (i.e., members or participants) in a product test group familiarize themselves with both peelers through actual usage, the participants are asked to use their memories of each experience as anchor points on a scale that is established by physical behavior using an input device (e.g., an analogue dial) that controls a grayscale of a display device. As previously described, the product evaluation module 114 that controls the grayscale also records a participant's expression of preference through cross-modality matching by recording the grayscale value of the color on the screen in a log 126 not seen by the participant. The quantitative results may then be compared to a ranking of the tested objects to “check” the results.

This section includes a detailed description of example participants; a study protocol; materials and instruments; the proposed data analysis; counterbalancing; the session script used by the interviewers, and so on. Example graphs and tables are then discussed which may be incorporated within a product evaluation report.

Session Protocol

| Time | | Activity |
|---|---|---|
| 5 | minutes | Lab tour and signing of forms |
| 1 | minute | Brief description of purpose of study |
| 2 | minutes | Practice using dial with a product evaluation device and |
| | | grayscale application; participants will be asked to turn dial all the way to |
| | | one end of the continuum [black] then all the way to the other end [white] |
| | | before choosing a point. |
| 2 | minutes | Peel carrot with anchor point peelers, then anchor point peelers |
| | | are placed on either side of measurement PC. |
| 2 | minutes | Participant is shown the screen (white or black) to be associated |
| | | with each anchor peeler; practice using the dial to go from gray |
| | | to the screen associated with each peeler. |
| 1 | minute | Write a sentence with the practice pen and rate on scale; pen |
| | | order counterbalanced across participants. |
| 3 | minutes | Do ratings with three different pens |
| 1 | minute | Participant returns to the anchors peelers, handles them to get |
| | | re-acquainted with the experience of using each one, uses the |
| | | dial to show the rating associated with each anchor. |
| 1 | minute | Perform mouse tasks with practice mouse and rate it |
| 4 | minutes | Perform ratings with three different mice |
| 1 | minute | Participant returns to the anchor peelers, handles them to get re- |
| | | acquainted with the experience of using each one, uses the dial |
| | | to show the rating associated with each anchor. |
| 1 | minute | Peel carrot with practice peeler |
| 4 | minutes | Perform ratings with three different carrot peelers |
| 3-5 | minutes | Place the anchors on the desk separated by about three feet; ask |
| | | the participant to place all the mice, pens, and peelers in a single |
| | | row with the anchors. |
| 10-15 | minutes | Discussion of rating experience: |
| | | How did you come up with this order? |
| | | There are places where a pen is next to a peeler is next to |
| | | a mouse. How did you decide this order? |
| | | Have you ever used any of these specific items before? |
| | | Tell me about using the screen and the dial. How did that |
| | | go? |
| | | Were any of objects particularly hard or easy to use with |
| | | the screen? |

### Products

The products and supporting materials in this example product evaluation include six vegetable peelers, four computer mice, four ballpoint pens, and several carrots. The example products are described as follows:

| | |
|---|---|
| Anchor Peeler: Swing-A-Way Surgical | |
| Stainless Peeler | |
| Model Number 327 | |
| Swing-A-Way Products, LLC | |
| Retail Price: $2.99 | |
| Label in Analysis: “Swingaway” | |
| Anchor Peeler: OXO Steel Swivel Peeler | Awards |
| Model Number 50081 | Tylenol/Arthritis |
| World Kitchen Incorporated | Foundation |
| Retail Price: $9.99 | Design Award |
| Product Design by Smart Design, Incorporated | Museum of Modern Art, |
| Label in Analysis: “OXO” | permanent collection |
| | Cooper-Hewitt National |
| | Design Museum, |
| | permanent collection |
| | Industrial Design |
| | Excellence Awards, |
| | Gold Medal |
| | Chicago Athenaeum |
| | Museum of |
| | Architecture and Design, |
| | permanent collection |
| Prepara Trio Three Blade Peeler | |
| Model Number PP01-Pe100 | |
| Prepara Chef's Performance Tools | |
| Retail Price: $14.99 | |
| Product Design by Pollen Design | |
| Label in Analysis: “Prepara” | |
| Calphalon Vegetable Peeler | |
| Model Number GT101 | |
| Calphalon, A Newall Rubbermaid Company | |
| Retail Price: $7.99 | |
| Label in Analysis: “Calphalon” | |
| Kyocera The Perfect Peeler | |
| Model Number CP-20RD | |
| Kyocera Tycom Corporation | |
| Retail Price: $19.99 | |
| Label in Analysis: “Kyocera” | |
| ProFreshionals Peeler and Bean Slicer | |
| Model Number 72001 | |
| Bradshaw International, Incorporated | |
| Retail Price: $3.99 | |
| Label in Analysis: “Profresh” | |
| Microsoft Basic Optical Mouse | |
| Model Number 1113 | |
| Microsoft Corporation | |
| Retail Price: $14.99 | |
| Label in Analysis: “MS Basic” | |
| Dynex Optical Mouse | |
| Model Number DX-WMSE | |
| Dynex Products | |
| Retail Price: $16.49 | |
| Label in Analysis: “Dynex” | |
| Logitech Gaming Grade Optical Mouse | |
| Model Number MX518 | |
| Logitech International | |
| Retail Price: $54.99 | |
| Label in Analysis: “Logitech” | |
| Razer Lachesis High Precision 3G Laser | |
| Gaming Mouse | |
| Model Number RZ01-00170100 | |
| Razer USA Ltd | |
| Retail Price: $79.99 | |
| Label in Analysis: “Razer” | |
| Cross Vapor Ballpoint Pen | |
| Model Number AT0012CS-3 | |
| A. T. Cross Company | |
| Retail Price: $22.99 | |
| Label in Analysis: “Cross” | |
| Faber-Castell e-Motion Ballpoint Pen with | |
| Pearwood Barrel | |
| Model Number 14 83 39 | |
| Faber-Castell Aktiengesellschaft | |
| Retail Price: $29.99 | |
| Label in Analysis: “Faber-Castell” | |
| Uniball 207 Premier Gel Pen | |
| Model Number PP01-Pe100 | |
| Sanford LP Corporation | |
| Retail Price: $6.99 | |
| Label in Analysis: “Uniball” | |
| Montblanc Meisterstück Le Grand | |
| Model Number 11402 RB 162 | |
| Montblanc-Simplo GmbH | |
| Retail Price: $350.00 | |
| Label in Analysis: “Montblanc” | |

### Instruments

Two computers are used in the evaluation of this example. One computer is used for evaluating the computer mice. This computer uses to a USB hub to attach the four computer mice to be evaluated. The second computer, referred to as the measurement PC in the following discussion (and which may or may not correspond to the product evaluation apparatus 102 of FIG. 1) executes a product evaluation module to measure and record the participant's ratings.

At its start, the product evaluation module 114 displays a full-screen 50% gray field and prompts the interviewer to enter the participant's first and last names. The name, along with a date and timestamp, may be used to denote a hidden log 126 into which the ratings are to be recorded during the session. A pre-linguistic input device (e.g., a Griffin PowerMate USB Multimedia Controller) may be used to manipulate a display on the screen. Using this dial, for instance, the participant may increase or decrease the grayscale value of the display color. When the dial is pressed, a beep may sound indicating the grayscale value (0-255) has been recorded into the log. After a two-second pause, the displayed grayscale value may reset to 50%, i.e., a value of “128” in a grayscale of zero to 255. The interviewer may end the evaluation by pressing the “[ESC]” key.

### Counterbalancing

In the following example, each of the participants uses the same objects. The participants use and rate each group of objects in the same order: pens, computer mice, and then peelers. Within each group of objects, the participants use and rate the same object first, as practice. The following factors may be counterbalanced across the participants.

### Anchor Assignment:

OXO peeler placed on left (white on the grayscale)/Swingaway peeler placed on right (black on the grayscale)
Swingaway peeler placed on left (white on the grayscale)/Oxo peeler placed on right (black on the grayscale)

### Pen Orders:

M Cross (practice), Montblanc, Faber-Castell, Uniball
F Cross (practice), Faber-Castell, Uniball, Montblanc
U Cross (practice), Uniball, Montblac, Faber-Castell

### Mouse Orders:

R MS Basic (practice), Razer, Logitech, Dynex
L MS Basic (practice), Logitech, Dynex, Razer
D MS Basic (practice), Dynex, Razer, Logitech

### Peeler Orders:

C Prepara (practice), Calphalon, Kyocera, Profresh
K Prepara (practice), Kyocera, Profresh, Calphalon
P Prepara (practice), Profresh, Calphalon, Kyocera

### Evaluation Session Script

The following is an example evaluation session script to be followed to obtain an evaluation that utilizes the pre-linguistic and linguistic basis techniques previously described. The bulleted items below indicate an example of language that may be used by an interviewer during a product evaluation session. Bracketed text indicates actions, notes, instructions and other considerations that may be noted by the interviewer during the evaluation session.
Thank you for coming in today.
Usually when you come in for a usability study, you try out some new software and tell us what you think about it. Today's study is going to be fairly different.
We will go through this step by step: First, check out this dial. Go ahead and give the top a twist—what happens on the screen when you do this? Now, twist it the other way. [If they do not comment on screen changes, tell them: the screen changes when you turn it.]
Now turn the dial in either direction and see how far you can go. Can you get it to a point where it stops changing? [If they do not turn far enough, coach them to go a bit further.]
Now give the top of the dial a solid push and . . . there's the beep. How about the other way? See if you can get the screen to a place where it stops changing. And press it. Great.
Let's do this one more time—show me where it stops changing when you go this way, and press; and now the other way, great.
Now, I'll show you how you'll use the dial in just a second. First, let's move over here. [Move to the table with the carrots and the vegetable peelers used for anchoring. Show the participant the two peelers.]
Here are two vegetable peelers. I want you to use each one, one at a time, and while you're using each one, think about how it feels, pay attention to your experience with it. When you feel like you have a good sense of your experience with one peeler, go ahead and try the other one. And while you're doing this, I don't want you to talk. Just concentrate on how it feels. [Watch as participant uses each peeler.]
Okay, let's move back to the dial. [Double check whether the OXO goes on the left or the right according to the counterbalancing plan. Place the anchor peelers on the appropriate sides of the dial.]
Okay, now watch this. I'm going to put this peeler here, and this peeler here. [Turn the dial towards the setting for one of the peelers.]
See the screen, I turned it until it stopped changing—I want you to associate this screen with this peeler. This screen represents your experience, how it felt to use this peeler. [Turn the dial towards the other setting.]
Now here is the other screen. It is not changing any longer. I want you to associate this screen with this peeler. Use this to represent your experience with this peeler. [Press ENTER to reset color to 50% gray. Point to one of the peelers as you talk.]
Okay, your turn—use the dial and show me the screen that represents your experience with this peeler. Go ahead and press it. And now show me the screen that represents your experience with the other peeler.
And just for practice, let's do this again—the screen that goes with this peeler? And the one for this peeler? Great.

### Pens

[Give the user the Cross pen and a practice sheet containing the sentence: The quick brown fox jumps over the lazy dog.]
So here's the tricky part: go ahead and use this pen to copy this sentence. Just as you did with the peeler, think about how it feels, what the experience is like.
Now use the dial and show me the screen that matches your experience that represents how it felt to use the pen. You already know what screen represents this peeler and what screen represents this peeler. Your experience with the pen can be any screen you like, any of the other screens that you can see.
[Make sure they understand that they can use the entire spectrum, not just the anchor screens. Turn over the pen task sheet and hand them the next pen. Watch as they try the pen and then use the dial and screen. Repeat this until they've gone through all three pens. Refresh their experience with the anchor peelers.]

### Computer Mice Evaluation

Great, now we are going to do the same kind of thing, but this time with these mice. But first, let's get re-acquainted with the two peelers and the screens that go with them.
One at a time, please pick up and handle one of the peelers. Remind yourself of what it felt like—what your experience was—and then use the dial to show me the screen that goes with it. And now, the same with the other peeler. [Move your chair to the end of the table and ask them to slide their chair in front of the other computer and give them the practice mouse.]
I have four mice here and four documents. Each document contains a set of things you can do with the mouse—a set of instructions. Start with this one, just double-click on the file called Mouse1, and open it up.
Just follow the instructions contained in the document, and think about how it feels to use this mouse. [Help them with any of the tasks if they need help, for example, show them how to drag, show them the scroll wheel, and point out the word mouse in the paragraph. If they want to move the mouse around more or click more, that is fine. Let them close the document and do not save the changes.]
Now go back to the dial. Thinking about your experience with the mouse, find the screen that matches that experience. [Repeat with the three other mice.]
Re-acquaint yourself with the two peelers here and the screens that go with them. Please pick up and handle one of the peelers. Remind yourself of what it felt like, about your experience, and then use the dial to show me the screen that goes with it. And now, the same with the other peeler. [Have the participant move to the peeler station and give them the first peeler.]
Alright, now we are doing the same thing with other peelers. Pay attention to how each feels, and what the experience is like. When you have a sense of what each is like to use, use the dial, and indicate the screen that matches your experience. [Hand them each peeler in turn.]

### Use an Ordinal Ranking to Check Pre-Linguistic Results

[When they finish rating the last peeler ask them to stay seated in front of the dial. Move the dial to the left. Gather the four peelers and put them next to the pens. Unplug the mice and put them with the pens and the peelers. Turn the monitor so it faces the end of the table and pull the keyboard to the end of the table.]
Let me set this up: you have used four pens, four mice, and four peelers. [Place the left-hand anchor peeler to the left and the right-hand anchor peeler to the right with about 3-4 feet of space in between.]
That peeler goes there, and that peeler goes there. I want you to place all the objects in a single row, in order with these [indicate the anchors] two peelers. It's fine to mix them up, but make sure they are in a single row. If you need to use the pens again, go ahead. You can move the mice around and click them. You may use the peelers again. [While the participant is ordering the items, connect your mouse to the USB hub to collect the participants' verbal reports and update the subject and counterbalancing information.] [When they are done putting the objects in order, ask the following questions, and enter their answers.]

### Linguistic Basis

Tell me about this order. How did you come up with it?
I can see that there are places where there is a pen next to a mouse next to a peeler. Are these in a certain order? How did you decide which went where? [Tease out their sense of why one object is positioned next to another. If the participant says the objects are “grouped” and in no particular order within the group, see if you can get them to think about it a little more and order the individual items relative to each other. If they cannot, make a note of this and proceed.]
Do any of these actually belong here? [Indicate to the outside of the anchor that is closest to you. If they say yes, let them re-arrange the objects to go beyond the anchors.]
Have you ever used any of these particular objects before?
Tell me about the screen. What was it like to use? How did you decide what screen went with an object?
Were any of the objects particularly hard or easy to match to a screen?

### Evaluation Report Analysis and Description

This section contains the analysis and discussion that lends support to the above described techniques. This analysis may also be incorporated within a product evaluation report 134 that may be output as a result by the product evaluation module. The analysis includes a description of the analyses performed, an analysis of variance (ANOVA), average and median ratings, relative comparisons, correlational statistics, and the relationship between ratings and rankings for each object tested.

In order to evaluate if participants were able to use the scale to differentiate the objects and to determine if there were any gender effects or effects of right-hand versus left-hand anchor placement, a mixed Analysis of Variance (ANOVA) may be performed on the data.

The “within-subject” factors (e.g., those measures that are the same for each participant) are the object type (pens, mice, and peelers) along with the specific objects. The “between-subject” grouping factors are gender (male versus female) and anchor placement—OXO on the left at darkest setting of grayscale value of 0 versus OXO on the right at lightest setting with grayscale value of 255. Exactly half the participants had OXO-left placement and half had OXO-right placement. Half the participants were men, and half were women. Approximately half of each gender had the OXO-left versus OXO-right placement: seven or eight in each group. Note: each rating for OXO-left placements were transposed to maintain consistency of Swingaway anchor value at 0 and OXO anchor value at 255.

The ANOVA analysis includes data from each of the objects except the practice objects: the Cross pen, the MS Basic mouse, and the Prepara peeler. These objects were not randomized for order within each object type, and therefore are not valid for data analysis in this example.

### ANOVA Statistics

The following table contains the ANOVA statistics with those effects statistically significant at the p<0.05 level are bolded.

| | | | | | |
|---|---|---|---|---|---|
| | Type III | | | | |
| | Sum of | | Mean | | |
| Source | Squares | df | Square | F | Sig. |

WITHIN SUBJECT EFFECTS

| | | | | | |
|---|---|---|---|---|---|
| ObjectType | 67350.32 | 2.00 | 33675.16 | 6.87 | 0.0022 |
| ObjectType * Gender | 458.16 | 2.00 | 229.08 | 0.05 | 0.9544 |
| ObjectType * Anchor | 5478.74 | 2.00 | 2739.37 | 0.56 | 0.5751 |
| ObjectType * Gender * Anchor | 4094.99 | 2.00 | 2047.49 | 0.42 | 0.6606 |
| Error(ObjectType) | 254770.08 | 52.00 | 4899.42 | | |
| Object | 127050.64 | 2.00 | 63525.32 | 10.30 | 0.0002 |
| Object * Gender | 2403.62 | 2.00 | 1201.81 | 0.19 | 0.8236 |
| Object * Anchor | 937.26 | 2.00 | 468.63 | 0.08 | 0.9270 |
| Object * Gender * Anchor | 25642.51 | 2.00 | 12821.25 | 2.08 | 0.1355 |
| Error(Object) | 320866.08 | 52.00 | 6170.50 | | |
| ObjectType * Object | 86166.63 | 4.00 | 21541.66 | 3.28 | 0.0141 |
| ObjectType * Object * Gender | 19360.07 | 4.00 | 4840.02 | 0.74 | 0.5683 |
| ObjectType * Object * Anchor | 6250.61 | 4.00 | 1562.65 | 0.24 | 0.9162 |
| ObjectType * Object * Gender * Anchor | 7986.58 | 4.00 | 1996.65 | 0.30 | 0.8745 |
| Error(ObjectType * Object) | 682331.40 | 104.00 | 6560.88 | | |

BETWEEN SUBJECT EFFECTS

| | | | | | |
|---|---|---|---|---|---|
| Intercept | 4552223.63 | 1.00 | 4552223.63 | 836.20 | 0.0000 |
| Gender | 41.07 | 1.00 | 41.07 | 0.01 | 0.9315 |
| Anchor | 6503.11 | 1.00 | 6503.11 | 1.19 | 0.2844 |
| Gender * Anchor | 14829.41 | 1.00 | 14829.41 | 2.72 | 0.1109 |
| Error | 141541.89 | 26.00 | 5443.92 | | |

### Evaluation Report Ratings

The following depicts example graphs that may be output as a part of a product evaluation report. FIG. 3 depicts an example graph 300 which shows an average rating in grayscale. The ANOVA statistics described above reveal a strong effect for the individual objects, indicating that participants rated each object uniquely. There is also an effect for object type, meaning that participants may have rated one particular type of object in a different way than another type. Third, there was an interaction between object type and object. Error bars in the graph 300 of FIG. 3 show a 95% confidence interval around the average for each object

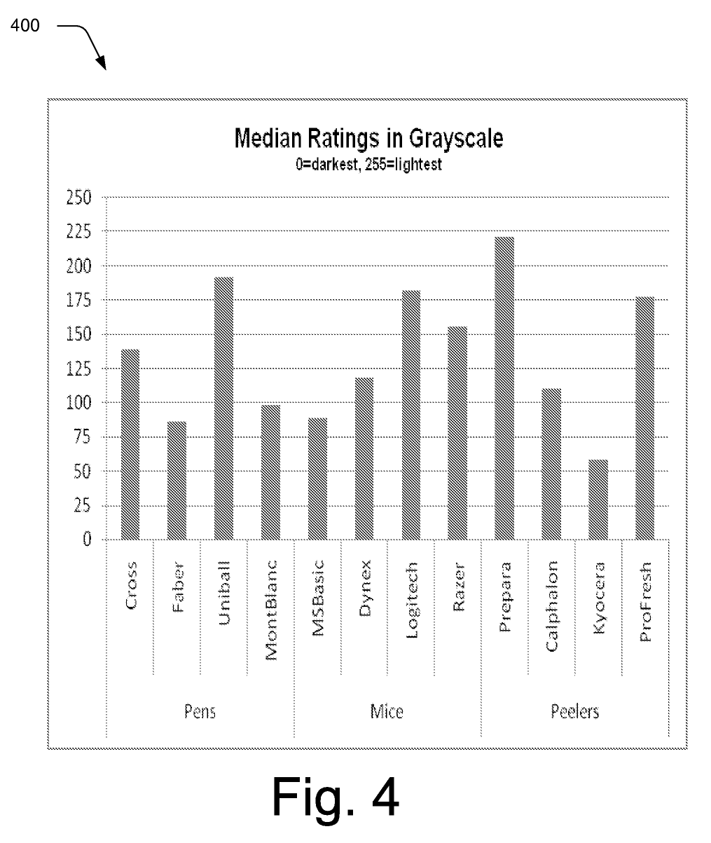

The graph 300 illustrates stronger differences between ratings with the Pen object type (especially when not including the Cross practice pen), and within the Peeler object type, than within the Mouse object type. This is most likely cause of the interaction effect. Also, the Pens and the Peelers have more extreme average ratings than the Mice, which may explain the main effect of Object Type. Statistically significant effects or interactions were not observed for the between-subject factors of Gender and Anchor placement. FIG. 4 depicts an example graph 400 that shows a median rating score for each object, to compare with the averages shown above.

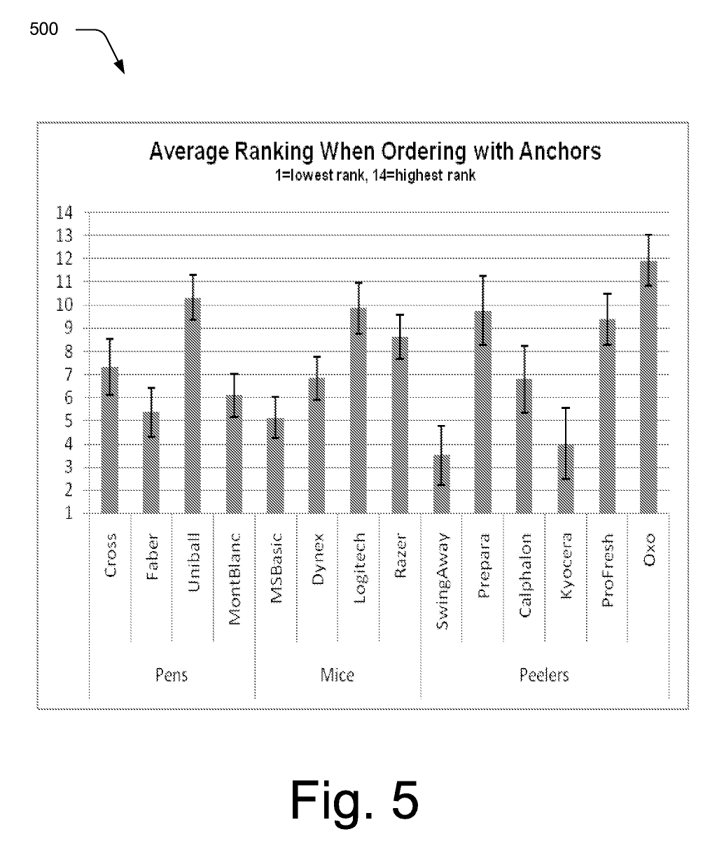

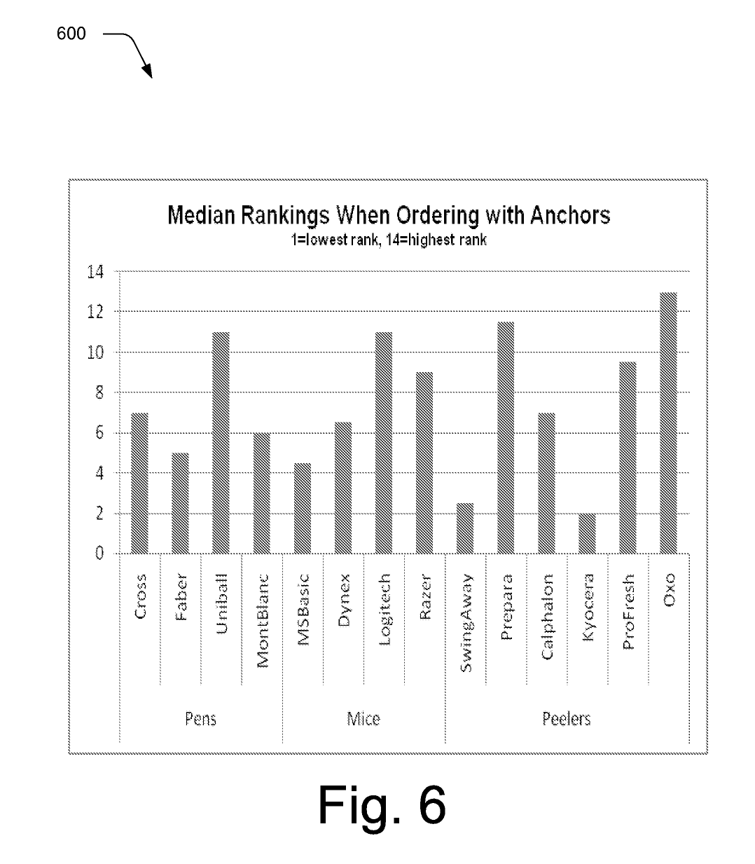

The product evaluation report may also compare the ratings to the overall ranking of objects. FIGS. 5 and 6 depict example graphs 500, 600, respectively, for average and median ranking of each of the objects, including the practice objects and the two anchors. Participants were allowed to move the anchors from the endpoints of the ranking if desired.

Having found that participants could distinguish between objects when comparing using the grayscale, correlational analyses may be used to explore the comparison between the grayscale ratings and the ordinal ranking for each object. In other words, this comparison may “check” consistency of the pre-linguistic evaluation, which may also be included in the product evaluation report. The practice objects are included in these analyses in order to take advantage of the entirety of the ranking data. The following table contains the correlation statistics.

| | Correlation | |
|---|---|---|
| Object | Coefficient | Sig. |
| Calphalon | .604(**) | 0.000413 |
| Cross | .422(*) | 0.020327 |
| Dynex | .384(*) | 0.036024 |
| Faber | .408(*) | 0.02517 |
| Kyocera | .679(**) | 3.69E−05 |
| Logitech | .416(*) | 0.022224 |
| MontBlanc | .505(**) | 0.004444 |
| MSbasic | .498(**) | 0.005114 |
| Prepara | .493(**) | 0.005656 |
| Profresh | 0.149021 | 0.4319 |
| Razer | .638(**) | 0.000148 |
| Uniball | .633(**) | 0.000173 |

(*)Correlation is significant at the 0.05 level (2-tailed).
(**)Correlation is significant at the 0.01 level (2-tailed).

At the p<0.01 level, seven out of twelve analyses were statistically significant. These significant correlations indicate the participants tended to rate and rank objects similarly (higher on the grayscale linked with higher in object ordering). Computing a simple binomial probability of seven out of twelve significant effects, with chance significance of 0.05, give a less than 0.001 probability of having that many correlations. At the p<0.05 level, eleven out of twelve analyses yield significant correlations.

### Simulation of Consumer Behavior

It has been observed that the participants' behavior using the pre-linguistic techniques described herein resemble consumer decision-making behavior in shopping situations. For example, two subjects in an experiment described above that serves as a basis for the example implmenetation articulated this phenomenon as follows: Subject 21 put objects “in the order that I [she] would buy them” and Subject 33 “tended to think [‘W]ould I purchase them?’”

### Conclusion

The experiment was constructed to observe whether people can reliably evaluate and communicate perceptions of product quality differences using a variant of magnitude estimation. Cross-modality matching technique was employed to enable a pre-verbal form of expression.

Both the statistical and qualitative results indicate the approach is sound. The quantitative analyses show no gender or object-order effects; and that there is a reasonable correlation between the rating and rankings of objects-yet, the verbal feedback shows that the semantic articulation of the factors that guided the judgments was inconsistent among users. This observation indicates a possible weakness in typical approaches that supply subjects with word-pairs upon entering a study.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
obtaining a pre-linguistic evaluation of one or more products and two or more anchor products, respectively, in which the two or more anchor products exhibit an intended design behavior of the one or more products; and
collecting a linguistic basis for the pre-linguistic evaluation of the one or more products after the pre-linguistic evaluation is performed.

2. A method as described in claim 1, wherein the two or more anchor products exhibit varying degrees of the intended design behavior.

3. A method as described in claim 1, wherein the pre-linguistic evaluation of the one or more products and the two or more anchor products, respectively, is obtained and collected from each of a plurality of members of a product evaluation group.

4. A method as described in claim 1, wherein the pre-linguistic evaluation of the one or more products and the two or more anchor products, respectively, is obtained through manual adjustment of a gray-scale display.

5. A method as described in claim 1, wherein the pre-linguistic evaluation of the one or more products and the two or more anchor products, respectively, is obtained without entry or viewing by a user of numbers or letters.

6. A method as described in claim 1, further comprising quantifying each said pre-linguistic evaluation of the one or more products and the two or more anchor products.

7. A method as described in claim 6, wherein a result of the quantifying is stored in a log that is not viewable by members of a product evaluation group that supplied the pre-linguistic evaluation until after the linguistic basis has been supplied.

8. A method as described in claim 6, further comprising correlating the linguistic basis with the quantified pre-linguistic evaluations of the one or more products and the two or more anchor products.

9. A method as described in claim 8, further comprising outputting a result of the correlation as a product evaluation report.

10. A method as described in claim 1, further comprising checking each said pre-linguistic evaluation for consistency.

11. A method as described in claim 10, wherein the checking is performed by:
quantifying each said pre-linguistic evaluation of the one or more products and the two or more anchor products;
receiving a ranking of the one or more products and the two or more anchor products; and
determining whether the quantified pre-linguistic evaluations of the one or more products and the two or more anchor products correspond to the received ranking of the one or more products and the two or more anchor products.

12. A method comprising:
determining an intended design behavior of one or more products;
selecting two or more anchor products that exhibit varying degrees of the intended design behavior; and
evaluating the product by obtaining a pre-linguistic evaluation of the one or more products and the two or more anchor products and then collecting a linguistic basis for the pre-linguistic evaluation.

13. A method as described in claim 12, wherein:
at least one of the two or more anchor products exhibits the intended design behavior in a way that is desired in the one or more products; and
another one of the two or more anchor products exhibits the intended design behavior in a way that is not desired in the one or more products.

14. A method as described in claim 12, wherein the pre-linguistic evaluation of the one or more products and the two or more anchor products is obtained using cross-modality matching.

15. A method as described in claim 12, further comprising checking each said pre-linguistic evaluation for consistency using an ordinal ranking that involves the one or more products.

16. One or more computer-readable media comprising instructions that are executable to:
receive an input from one or more members of a product evaluation group for a pre-linguistic evaluation of one or more products and two or more anchor products, respectively;
quantify each said pre-linguistic evaluation of the one or more products and the two or more anchor products;
receive a linguistic basis for the pre-linguistic evaluation of the one or more products after the input for the pre-linguistic evaluation is received; and
output a product evaluation report that correlates the quantified said pre-linguistic evaluation with the linguistic basis for respective said members of the product evaluation group.

17. One or more computer-readable media as described in claim 16, wherein the two or more anchor products exhibit an intended design behavior of the one or more products.

18. One or more computer-readable media as described in claim 16, wherein the input is received without outputting or receiving a number or letter from the one or more members of the product evaluation group.

19. One or more computer-readable media as described in claim 17, wherein the input is received in response to movement of an input device that causes different shades of gray to be displayed on a display device.

20. One or more computer-readable media as described in claim 16, wherein the quantified each said pre-linguistic evaluation is not output for display to the one or more members of the product evaluation group.
